(19) United States
(12) Patent Application Publication
(10) Pub. No.: US 2006/0129663 A1
(43) Pub. Date: Jun. 15, 2006

(54) Computer-assisted production tracking system with production data traceability

(76) Inventor: Raphael Labourier, Besancon (FR)

Correspondence Address: YOUNG & THOMPSON, 745 SOUTH 23RD STREET, 2ND FLOOR, ARLINGTON, VA, 22202, US

(21) Appl. No.: 10/537,662

(22) PCT Filed: Dec. 8, 2003
(86) PCT No.: PCT/FR03/03626

§ 371 Date: Nov. 30, 2005

(30) Foreign Application Priority Data
Dec. 6, 2002 (FR) 02/15425

(51) Int. Cl. G06F 15/173

(52) U.S. Cl. 709/223

(57) ABSTRACT

A computer-assisted production tracking system for one or more machines, the machines having at least one primary real time system including at least one input which is connected to at least one machine and/or to at least one secondary real time system of the machine(s) and at least one output which is connected to at least one server. The primary and/or secondary real time systems include a program for determining the operating mode of the machine and/or the operating time in each of the modes. The server makes the information available to client computers. The primary and/or secondary real time system(s) include a program for allocating a date and time to each piece of dynamic information received and recording the information in at least one timestamp file.

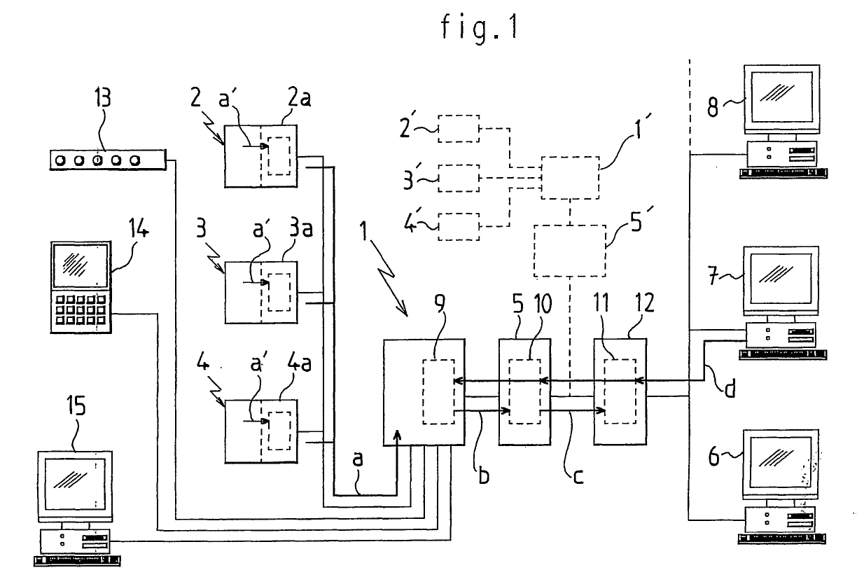

The invention relates to the development of a production tracking system intended to manage a variable number of machines and to process information transmitted by said machines in real time, said development allowing to ensure the traceability of the production data by time stamping the production events such as the frequency, the changing of the state of the machine, the changing of an operator, etc.

In the field of production tracking, we are well aware of systems constituted of a box connected to one or several machines,—the term machine means industrial production equipment that can be controlled by traditional electric equipment, programmable automaton or numerical control—, said box comprising a keyboard and a two to eight type-line display screen. Each box comprises a microprocessor onto which a program is installed allowing to count the number of items produced by the machine connected to said box, to determine the operating mode and to record the defects that occurred on the machine, the operating mode and the inputting of errors being carried out by the operator via the keyboard. The item counting, operating mode and error data allows to determine the operating time of the machine in each of its operating modes as well as the data related to the manufacturing order, the latter data being read either by the box or by a PC type computer connected to said box, this is what we call computer-assisted production tracking CAPT.

These CAPT systems comprising such boxes have numerous inconveniences, indeed, these boxes generally comprise a finite and limited number of inlets, that being a limited number of connections to the machines, so that it is difficult to adapt a box to the changing needs of the users, notably an increase in the number of machines or a modification to the machines when it is usually necessary to change the boxes which are particularly costly. Another inconvenience consists in the fact that the programs in these boxes are in computer language. This computing language is especially complex thus rendering a reprogramming of the box difficult, lengthy and, consequently, costly. Finally, these boxes have a cycle time greater than or equal to 100 ms which, given the frequency of the current machines, does not allow to process all the data issuing from all the machines connected to the box.

In order to resolve these inconveniences, we have already imagined a computer-assisted production tracking system of one or several workshops or production lines comprising a real time system which determines the operating mode of said machine and/or the operating times in each of these modes; this is the case, for example, of the French patent application FR 2.814.260 which describes a computer-assisted production tracking system. The production tracking system consists of at least one real time system comprising at least one inlet which is connected to at least one machine and at least one outlet which is connected to at least one server, said real time system comprising a program which can gather data known as dynamic transmitted by the machine and determine the counting of parts and the cycle time as well as the operating time in each of these modes. The program uses this data to deduce the operating mode of the machine and the server puts the data from the real time system into web page format to make it available to client computers which are connected to the server via an Intranet or Ethernet network.

The real time system advantageously consists in a programmable automaton or in the real time part of a PC type computer, which allows for considerable adaptability and the processing of all the data issuing from the machines, the real time system having a cycle time of less than 20 ms. Furthermore, we notice that the programmable automaton or a real time part of a PC can receive a variable number of inlets, that being connections to machines, and employ easy-to-use program languages so that the production tracking system does not have to be changed when there are developments in production, such as, for example, the adding of new machines; it only needs to be reprogrammed.

However, this production tracking system has the inconvenience of not allowing users to ensure the traceability of their production.

One of the purposes of the invention is therefore to resolve these inconveniences by proposing a new computer-assisted production tracking system allowing to ensure the traceability of production, that meaning to date stamp all the production events such as the frequency, the changing of the state of the machine, the changing of an operator, the material batches, servicing work, manufacturing orders, temperature and pressure readings, etc., that is reliable, easily adaptable to the development of the machines or the data needed for production tracking and inexpensive.

In this respect and in accordance with the invention, a computer-assisted production tracking system of one or several workshops or production lines is proposed respectively comprising one or several machines, consisting of at least one primary real time system comprising at least one inlet connected to at least one machine and/or at least one secondary real time system of the machine(s) and at least one outlet connected to at least one server, said primary real time system and/or the secondary real time system comprising a program which can determine the operating mode of said machine and/or the operating time in each of these modes from the dynamic data transmitted by the machine and/or the secondary real time system, the server putting the data from the primary real time system into web page format to make it available to client computers of the different production, quality or similar departments that are connected to the server via an Intranet or Internet network and equipped with a web browser so as to read said web pages, said system is remarkable in that the primary and/or secondary real time system comprises a program which can allocate a date and a time to each piece of dynamic data received and record this date stamped data in at least one timestamp file so that the server can make this date stamped data available to the client computers in the form of one or several web page(s).

Other advantages and features will come out of the description that follows of several alternative embodiments, given by way of non-restrictive examples, of the computer-assisted production tracking system in reference to the sole drawing which is a diagrammatic representation of the computer-assisted production tracking system in accordance with the invention.

The production tracking system consists in a primary real time system 1 comprising several inlets respectively connected to a machine 2, 3 and 4 and at least one outlet connected to a server 5. The primary real time system 1 comprises a program which can determine the cycle time of each machine 2, 3 and 4 from “all or nothing” type or AON gathered data such as item counting data derived from the machines. The counting data, which, on the machine, consists in an electric pulse, is transformed into data known as dynamic binary data of 0 or 1 type which allows the program of the primary real time system 1 to determine the counting of items and the cycle time and then deduce the operating modes of said machine, for example: the first data of the cycle gives the set mode, an automatic mode is deduced after a certain number of cycle times and a stop mode is deduced after the absence of pulses over a pre-set number of cycles. Using this data known as dynamic, the program of the primary real time system 1 furthermore determines the operating time of the machine in each of the aforementioned modes.

Of course the operating mode can be determined directly either by the machine 2, 3 or 4 or by an operator. The dynamic data received by the primary real time system 1 as well as the dynamic data which have been deduced are transmitted to the server 5 which puts it into web page format, that being in html or similar computer extension file format, to make it available to the client computers 6, 7 and 8 of the different production, quality or similar departments which are connected to the server 5 via an Intranet or Ethernet network and equipped with a web browser, such as Netscape or Internet Explorer which are registered trademarks, in order to read said web pages.

Of course the web pages of the server 5 can be read by any such browser irrespective of the operating system on the client computers used to read them.

Furthermore, it goes without saying that the browsers on the client computers 6, 7 and 8 can be replaced by an application which generates a screen containing the data requested by the client computer 6, 7 or 8. The term application here means a computer program such as an executable, a JAVA (registered trademark) program or similar.

The web pages made available to the client computers 6, 7 and 8 by the web server 5 or the screens generated by the application consist, for example, in graphics, histograms, curves, pie charts, etc.

According to a first alternative embodiment of the production tracking system in compliance with the invention, the primary real time system 1 comprises a program which can allocate a date and a time to each dynamic data transmitted by the machine(s) 2, 3 and 4, as indicated by arrow a and record this date stamped data in a first file known as timestamp file 9. This timestamp file advantageously consists in a file known as dynamic, that being a computer file of constant size in which pieces of data can be recorded one after the other. The data contained in this first timestamp file 9 is than transmitted to the server 5, as indicated by arrow b which makes this date stamped data available to the computers 6, 7 and 8 in web page format. The first timestamp file 9 holding the date stamped data is transmitted to the server 5 at regular intervals so as to record said date stamped data on a second file known as timestamp file 10. The contents of the second timestamp file 10 of the server 5 are advantageously recorded onto a database 11, as indicated by arrow c, at regular intervals providing superior memory and data processing capacities. Indeed, the memory capacity of the server 5 corresponds to about one week of gathered data, which is not always enough for developed production tracking which sometimes needs to compare one month's production to that of another. This database 11 is recorded on an Intranet server 12 connected between the web page server 5 and the client computers 6 and 7. When the client computer 7, for example, connects to the server 5, said server 5 makes the date stamped data issuing from the first timestamp file 9 and/or the second timestamp file 10 and/or the date stamped data recorded on the database 11 depending on the needs of the client computer 7, as indicated by arrow d, available to said computer 7 in the form of web pages.

It goes without saying that the first timestamp file 9 holding the date stamped data can be transmitted to the server 5 when said first timestamp file 9 reaches a pre-set critical size, in order to record said date stamped data in the second timestamp file 10 and that the contents of the second timestamp file 10 of the server 5 can be recorded onto the database when said timestamp file 10 reaches a pre-set critical size whilst remaining within the scope of the invention.

Furthermore, at the end of recording the contents of the second timestamp file 10 onto the database 11, said contents of the second timestamp file 10 are deleted in order to allow the recording of new data in said second timestamp file 10.

According to an alternative embodiment of the system in compliance with the invention, the machines 2, 3 and 4 advantageously comprise real time systems known as secondary, respectively 2a, 3a and 4a, interconnected to the inlet of the primary real time system 1. In the same manner as above, the secondary real time systems 2a, 3a and 4a respectively comprise a program which can determine the counting of items and/or the cycle time from a seizing of binary data such as item counting data derived from the machines 2, 3 and 4, as indicated by arrows a′, and then deduce the operating modes of said machines 2, 3 and 4 and/or the operating time in each of these cycles. We thus notice that as the secondary real time systems 2a, 3a and 4a process some of the data, the primary real time system 1 is freed from some of said processing, which allows to connect a larger number of machines comprising or not comprising a secondary real time system to said primary real time system 1 whilst maintaining a data processing cycle time of less than 20 ms. The secondary real time systems 2a, 3a and 4a transmit, as indicated by arrow a, this dynamic data to the primary real time system 1 which comprises, in the same manner as above, a program which can allocate a date and a time to each piece of dynamic data transmitted by the secondary real time systems 2a, 3a and 4a and record this data in the first timestamp file 9, the server 5 making this date stamped data available to the client computers 6, 7 and 8 in the form of web pages. As above, the first timestamp file 9 holding the date stamped data is transmitted to the server 5 at regular intervals in order to record said date stamped data on a second file known as timestamp 10 whose contents are advantageously recorded onto a database 11 at regular intervals.

According to an alternative embodiment of the system in compliance with the invention, the secondary real time systems 2a, 3a and 4a respectively comprise a program which can allocate a date and a time to each piece of dynamic data transmitted by the machine 2, 3 and respectively 4 and record this data in the secondary real time systems 2a, 3a and 4a into the first timestamp file 9. This first timestamp file 9 is then transmitted to the server 5 at regular intervals in order to record said date stamped data in the second file known as timestamp 10 whose contents are advantageously recorded on a database 11 at regular intervals, a copy of the first timestamp file 9 can incidentally be recorded on the primary real time system 1.

Incidentally, the computer-assisted production tracking system further comprises a control box 13 connected to the primary real time system 1 placed next to the machine 2 so as to procure complementary dynamic data such as, for example, a stop cause related to said machine 2. The production tracking system advantageously comprises one or several control panels 14, of which only one is represented in the drawing next to the machine 3, connected to the primary real time system 1 and consists, for example, in a 16-character display screen and a keyboard. This control panel 14 allows the operator of the machine 3 to input a stop cause and, possibly, display or input the quantities discarded by said machine, the manufacturing orders or the references or any other dynamic data.

Of course the control panel 14 can advantageously consist in a barcode reader connected to a primary real time system 1 via a wired or radio link.

Moreover, this control panel 14 can also consist in a simple touch-sensitive screen.

Finally, we notice that the control box 13 and the panel 14 can be connected to the secondary real time systems 2a, 3a and 4a whilst remaining within the scope of the invention.

The primary real time system consists, for example, in a programmable automaton typically comprising a chassis enclosing an inlet and outlet unit and a central unit commonly known as CPU which is the abbreviation of Control Process Unity, the inlet and outlet unit, the central unit and a coupler being connected to the chassis in order to allow the transfer of data between the inlet and outlet unit and notably the central unit.

According to an alternative embodiment of the production tracking system in compliance with the invention, the primary real time system 1 can consist in the real time part of a PC type computer such as hardware, that being computer equipment, or software, that being a computer program, and an inlet and outlet unit.

According to a final alternative embodiment of the computer-assisted production tracking system, the latter advantageously comprises a thin client 15 connected to the web server 5 or the Intranet server 12 placed next to the machine 4 allowing its operator to input the causes of said machine 4 and display data relating to the actual production, quality, production, assembly, adjustment and maintenance files or plans, photos, etc. This thin client 15 consists in a PC type computer that does not have a hard drive, that being a computer comprising a monitor, a keyboard and a central processing unit consisting in a mother board and boards for connecting peripherals such as a video adapter, a sound adapter, etc. Furthermore, this thin client 15 allows operators to modify certain parameters of the program of the server 5 such as, for example, the theoretical cycle time of a machine or the theoretical number of items per cycle. Moreover, the dynamic data transmitted to the web server 5 are then directly recorded in the second timestamp file 10.

It goes without saying that the computer-assisted production tracking system can advantageously comprise analogue measuring devices placed on the machines 2, 3 and 4 and linked to the primary real time system 1 in order, for example, to control the quality of the items and possibly sort them. The dynamic data transmitted by this analogue measuring device is thus transmitted to the primary real time system 1, then date stamped and transmitted to the server 5 which makes it available to the client computers 6, 7 and 8 in the form of web pages.

Furthermore, the production tracking system can advantageously comprise one or several complementary primary real time systems 1 on the inlets to which the machines 2, 3 and 4 are connected which in turn are linked to a second web page server 5′, the servers 5 and 5′ being interconnected.

Finally, it goes without saying that the computer-assisted production tracking system can be adapted to all types of machines such as numerically controlled machines, for example, and that the examples given above are only specific non-restrictive illustrations of fields of application of the invention.

1. Computer-assisted production tracking system of one or several workshops or production lines respectively comprising one or several machines (2, 3, 4) consisting of at least one primary real time system (1, 1′) comprising at least one inlet connected to at least one machine (2, 3, 4) and/or at least one secondary real time system (2a, 3a, 4a) of the machine(s) (2, 3, 4) and at least one outlet connected to at least one server (5, 5′), said primary real time system (1, 1′) and/or the secondary real time system (2a, 3a, 4a) comprising a program which can determine the operating mode of said machine (2, 3, 4) and/or the operating time in each of these modes from the dynamic data transmitted by the machine (2, 3, 4) and/or the secondary real time system (2a, 3a, 4a), the server (5, 5′) making the date available to the client computers (6, 7, 8) of the different production, quality or similar departments that are connected to the server (5, 5′) via an Intranet or Internet network; said system is characterised in that the primary real time system (1, 1′) and/or secondary real time systems (2a, 3a, 4a) comprise a program which can allocate a date and a time to each piece of dynamic data it receives and record this data in at least a first file known as timestamp file (9) so that the server (5, 5′) can make this date stamped data available to the client computers (6, 7, 8).

2. Computer-assisted production tracking system set forth in claim 1, characterised in that the data received by the primary real time system (1, 1′) and/or the secondary real time systems (2a, 3a, 4a) consist in dynamic data transmitted by the machines (2, 3, 4) and/or by the secondary real time systems (2a, 3a, 4a) and/or at least one computer-assisted production tracking computer program or similar.

3. Computer-assisted production tracking system set forth in claim 1, characterised in that the data received by the primary real time system (1, 1′) and/or the secondary real time systems (2a, 3a, 4a) consist in the dynamic data transmitted by a control box (13) and/or by a control panel (14) and/or by analogue measuring devices connected to the primary real time system (1, 1′) or secondary real time systems (2a, 3a, 4a) and/or by a thin client (15) connected to the web server (5, 5′).

4. Computer-assisted production tracking system set forth in claim 3, characterised in that the first timestamp file (9) holding the date stamped data is transmitted to the server (5, 5′) at regular intervals so as to record said date stamped data on a second file known as timestamp file (10).

5. Computer-assisted production tracking system set forth in claim 1, characterised in that the first timestamp file (9) holding the date stamped data is transmitted to the server (5, 5′) when said file (9) reaches a pre-set critical size in order to record said date stamped data in the second timestamp file (10).

6. Computer-assisted production tracking system set forth in claim 1, characterised in that the contents of the second timestamp file (10) of the server (5, 5′) are recorded onto a database at regular intervals.

7. Computer-assisted production tracking system set forth in claim 1, characterised in that the contents of the second timestamp file (10) of the server (5, 5′) are recorded onto a database (11) when said timestamp file (10) reaches a pre-set critical size.

8. Computer-assisted production tracking system set forth in claim 4, characterised in that, at the end of recording the contents of the second timestamp file (10) onto the database (11), said contents of the second timestamp file (10) are deleted in order to allow the recording of new data in said second timestamp file (10).

9. Computer-assisted production tracking system set forth in claim 4, characterised in that, when the client computer (6, 7, 8) connects to the server (5, 5′), said server (5, 5′) makes the date stamped data issuing from the first timestamp file (9) and/or the second timestamp file (10) and/or the database (11) available to the client computer (6, 7, 8) in the form of web pages.

10. Computer-assisted production tracking system set forth in any claim 4, characterised in that the database (11) is recorded on an Intranet server (12) connected to the server (5, 5′).

11. Computer-assisted production tracking system set forth in claim 1, characterised in that the client computer(s) (6, 7, 8) comprise an application which generates a screen and/or a web page containing the data requested by the client computer (6, 7, 8).
